(19) United States
(12) Patent Application Publication
(10) Pub. No.: US 2018/0365664 A1
(43) Pub. Date: Dec. 20, 2018

(54) METHOD AND SYSTEM FOR PRODUCT SALES PROMOTION USING SALES PROFIT DISTRIBUTION

(71) Applicant: SV INC., Seoul (KR)

(72) Inventors: Yong Hyun Kang, Suwon-si (KR); Du Hyun Kim, Seoul (KR)

(21) Appl. No.: 16/056,404

(22) Filed: Aug. 6, 2018

Related U.S. Application Data
(63) Continuation of application No. PCT/KR2017/000768, filed on Jan. 23, 2017.

(30) Foreign Application Priority Data
Feb. 6, 2016 (KR) 10-2016-0015339
Jul. 4, 2016 (KR) 10-2016-0084447

(51) Int. Cl. G06Q 20/10; G06Q 20/06; G06Q 20/20

(52) U.S. Cl. CPC G06Q 20/108; G06Q 20/204; G06Q 20/065

(57) ABSTRACT

The disclosed technology may include: a product payment unit adapted to allow a payment for a sales price of a product to be made through a terminal of a purchaser; a member account unit allocated to a member who joins the product sales promotion system to allow cyber money to be deposited thereinto; an order calculation unit adapted to determine a distribution order in an order of a cyber money amount deposited in the member account unit; and a dividend distribution unit adapted to distribute cyber money corresponding to a purchaser dividend which is a portion of a dividend obtained by multiplying a paid amount for the sales price by a dividend distribution rate to the purchaser and to further distribute cyber money corresponding to a remaining dividend to at least some of members who rank ahead the purchaser in the distribution order, wherein after the dividend distribution unit distributes the cyber money corresponding to the purchaser dividend to the purchaser, the order calculation unit determines the distribution order.

### CROSS-REFERENCE TO RELATED APPLICATIONS

This patent document claims priority to and the benefit of PCT Application No. PCT/KR2017/000768 filed on Jan. 23, 2017 which claims priorities to Korean Patent Application No. 10-2016-0015339 filed on Feb. 6, 2016 and Korean Patent Application No. 10-2016-0084447 filed on Jul. 4, 2016. The above applications are all hereby incorporated by reference for all purposes as if fully set forth herein.

### TECHNICAL FIELD

Some implementations of the disclosed technology relate to a product sales promotion system and method.

### BACKGROUND ART

A consumption behavior in a conventional economic system is carried out by paying for a product in cash to obtain the product. Under such a structure, as more consumption is made, the cash assets of a consumer are reduced, so that the consumer has to stop or cut down his or her consumption so as to increase or maintain his or her cash assets.

If an economic depression occurs, the consumer reduces his or her consumption, and thus, product sales are reduced. Subsequently, product sellers reduce the number of workers or their wage due to the decrease of their sales, and therefore, the consumer's income becomes reduced, so that he or she reduces the consumption more and more, thereby making such a vicious circle to be repeated under such a structure.

If the cash assets of the consumer are increased as he or she increases consumption, however, the opposite phenomena to those mentioned above may occur. In detail, the consumer increases his or her consumption more, and accordingly, product sales are drastically increased. Also, the product sellers increase the number of workers or their wage through the drastic increase of their sales. Therefore, the consumer's income increases as well, which allows his or her consumption to increase as well. If such an economic system is achieved and continued, the world economy will be in the boom years.

### SUMMARY

Various implementations are provided to introduce a unique manner of distributing a portion of a sales profit to other members having larger cyber money than purchasers as well as the purchasers to increase the assets of the purchasers themselves through their consumption and the consumption of other members.

### Technical Solution

Some implementation of the disclosed technology provides a product sales promotion system for selling products on online including: a product payment unit adapted to allow a payment for a sales price of a product to be made through a terminal of a purchaser; a member account unit allocated to a member who joins the product sales promotion system to allow cyber money to be deposited thereinto; an order calculation unit adapted to determine a distribution order in an order of a cyber money amount deposited in the member account unit; and a dividend distribution unit adapted to distribute cyber money corresponding to a purchaser dividend which is a portion of a dividend obtained by multiplying a paid amount for the sales price by a dividend distribution rate to the purchaser and to further distribute cyber money corresponding to a remaining dividend to at least some of members who rank ahead the purchaser in the distribution order (hereinafter, referred to as “priority members”), wherein after the dividend distribution unit distributes the cyber money corresponding to the purchaser dividend to the purchaser, the order calculation unit determines the distribution order.

In some implementations, the dividend distribution unit may transfer a purchaser dividend obtained by multiplying the dividend by a purchaser distribution rate to the member account unit of the purchaser.

In some implementations, the dividend distribution unit may calculate individual priority member dividends from a priority member dividend obtained by subtracting the purchaser dividend from the dividend according to a priority member distribution way and transfer the individual priority member dividends to the member account units of the at least some of priority members.

In some implementations, the priority member distribution way may include the steps of: arranging the priority members according to the distribution order; distributing a first individual priority member dividend obtained by multiplying the priority member dividend by a priority member distribution rate to a first member who is a first in the distribution order; and distributing a second individual priority member dividend obtained by multiplying an amount remained after subtracting the first individual priority member dividend from the priority member dividend by the priority member distribution rate to a second member who is a second in the distribution order.

In some implementations, the priority member distribution way may be configured to distribute the priority member dividend to the at least some of priority members equally.

In some implementations, the order calculation unit may determine the distribution order in real time.

In some implementations, the order calculation unit may determine the distribution order every time a period of time of order calculation elapses.

In some implementations, the order calculation unit may determine the distribution order with respect to all of the members joined in the product sales promotion system.

In some implementations, the order calculation unit may determine the distribution order with respect to only the purchasers who purchase the products.

In some implementations, the at least some of priority members may be all of the priority members.

In some implementations, the at least some of priority members may be selected according to the distribution order in the order from a top priority member.

In some implementations, the at least some of priority members may be selected randomly selected among the priority members.

In some implementations, the member account unit may be adapted to allow the cyber money transferred directly from the member to be deposited thereinto.

Some implementation of the disclosed technology provides a product sales promotion method for selling products through a product sales promotion system including the steps of: (a) making the payment for a sales price of the product by a terminal of a purchaser, for a first period of time of order calculation, through a product payment unit; and (b) transferring cyber money corresponding to a portion of a dividend obtained by multiplying a paid amount for the sales price by a dividend distribution rate to a member account unit of the purchaser, through a dividend distribution unit; (c) determining a first distribution order according to a cyber money amount deposited into the member account unit, through an order calculation unit; and (d) transferring cyber money corresponding to a remaining dividend to the member account units of at least some of members who rank ahead the purchaser in the first distribution order (hereinafter, referred to as “priority members”), by a dividend distribution unit.

In some implementations, the portion of the dividend at the step (b) may be a purchaser dividend calculated by multiplying the dividend by a purchaser dividend rate, and the remaining dividend at the step (d) may be a priority member dividend calculated by subtracting the purchaser dividend from the dividend. The priority member dividend may be divided into individual priority member dividends according to a priority member distribution way, and the individual priority member dividends may be transferred to the member account units of the at least some of priority members.

In some implementations, the order calculation unit may determine a second distribution order, for a second period of time of order calculation, on the basis of the purchaser dividends transferred for the second period of time of order calculation and the individual priority member dividends transferred for the first period of time of order calculation.

In some implementations, the priority member distribution way may include the steps of: arranging the priority members according to the first distribution order; distributing a first individual priority member dividend obtained by multiplying the priority member dividend by a priority member distribution rate to a first member who is a first in the first distribution order; and distributing a second individual priority member dividend obtained by multiplying an amount remained after subtracting the first individual priority member dividend from the priority member dividend by the priority member distribution rate to a second member who is a second in the first distribution order.

In some implementations, the priority member distribution way may distribute the priority member dividend to the at least of priority members equally.

In some implementations, the step of determining the second distribution order may be carried out in real time.

In some implementations, the first distribution order and the second distribution order may be determined with respect to all of the members joined in the product sales promotion system.

In some implementations, the first distribution order and the second distribution order may be determined with respect to only the purchasers who purchase the products.

In some implementations, the at least some of priority members may be all of the priority members.

In some implementations, the at least some of priority members may be selected according to the distribution order in the order from a top priority member.

In some implementations, the at least some of priority members may be selected randomly selected among the priority members.

In some implementations, the cyber money transferred directly from the member may be deposited into the member account unit.

According to the implementations of the disclosed technology, a mechanism is provided for distributing a portion of sales profit to other members having larger cyber money than purchasers as well as the purchasers to increase the assets of the purchasers themselves through their consumption and the consumption of other members.

### DESCRIPTION OF DRAWINGS

FIG. 1 is an exemplary block diagram showing a configuration of a product sales promotion system according to an implementation of the disclosed technology.

FIG. 2 is an exemplary flowchart showing processes of selling products and distributing a dividend in the product sales promotion system according to an implementation of the disclosed technology.

FIG. 3 is an exemplary table showing an initial distribution order according to the amounts of cyber money of 10 purchasers who purchase clothing through the product sales promotion system according to the first implementation of the disclosed technology.

FIG. 4 is an exemplary table showing purchase amounts of 10 purchasers who purchase clothing for three days through the product sales promotion system according to an implementation of the disclosed technology.

FIG. 5 is an exemplary table showing the purchaser dividends transferred to the purchasers for a first period of time of order calculation and the amounts of cyber money retained updated on the basis of the purchaser dividends, which will be a standard for the first distribution order.

FIG. 6 is an exemplary table showing the first distribution order.

FIG. 7 is an exemplary table showing amounts transferred to the purchasers and profit rates of the purchasers for the first period of time of order calculation.

FIG. 8 is an exemplary table showing the purchaser dividends transferred to the purchasers for a second period of time of order calculation and the amounts of cyber money retained updated on the basis of the sum of individual priority member dividends for the first period of time of order calculation and the purchaser dividends for the second period of time of order calculation, which will be a standard for the second distribution order.

FIG. 9 is an exemplary table showing the second distribution order.

FIG. 10 is an exemplary table showing amounts transferred to the purchasers and profit rates of the purchasers for the second period of time of order calculation.

FIG. 11 is an exemplary table showing the purchaser dividends transferred to the purchasers for a third period of time of order calculation and the amounts of cyber money retained updated on the basis of the sum of individual priority member dividends for the second period of time of order calculation and the purchaser dividends for the third period of time of order calculation, which will be a standard for the third distribution order.

FIG. 12 is an exemplary table showing the third distribution order.

FIG. 13 is an exemplary table showing amounts transferred to the purchasers and profit rates of the purchasers for the third period of time of order calculation.

FIG. 14 is an exemplary table showing cyber money profit rates to the purchase amounts of the purchasers during an event.

### DETAILED DESCRIPTION

The disclosed technology can be implemented to provide a product sales promotion system and method. Therefore, there is a need for a system capable of providing a new economic structure wherein the cash assets of the consumer are increased as his or her consumption is increased.

Hereinafter, various implementations of the disclosed technology will be described in detail with reference to the accompanying drawings so that those skilled in the art can easily carry out the disclosed technology. In the following detailed description of the embodiments of the disclosed technology, a detailed description of known functions or configurations will be omitted. The same reference numerals are used throughout the drawings for portions having similar functions and actions. Hereinafter, a product sales promotion system and method according to an implementation of the disclosed technology will now be described in detail with reference to the attached drawings.

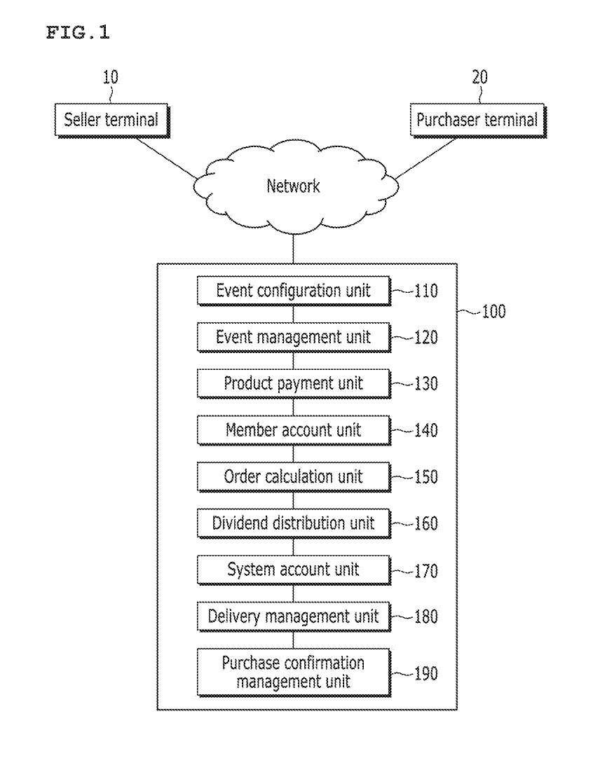

In addition, in the entire specification, when a part is referred to as being “connected” with another part, it is not only a case where it is directly connected, but also a case where it is indirectly connected with another element therebetween. Also, “comprising” and “including” mean that other components may be included, rather than excluding other components, unless specifically stated otherwise. FIG. 1 is an exemplary block diagram showing a configuration of a product sales promotion system according to an implementation of the disclosed technology.

A product sales promotion system 100 according to an implementation of the disclosed technology may include an event configuration unit 110, an event management unit 120, a product payment unit 130, a member account unit 140, an order calculation unit 150, a dividend distribution unit 160, a system account unit 170, a delivery management unit 180, and a purchase confirmation management unit 190.

The term “unit” as used herein may include software, hardware, or a combination thereof depending on the context in which the term is used. For example, the software may be machine code, firmware, embedded code, application software, or a combination thereof. Also, for example, the hardware may be a circuit, a processor, a computer, an integrated circuit, integrated circuit cores, or a combination thereof. The units may be implemented in one computer in some applications, or may be distributed in more than one computers or servers linked to a communication network to allow communications between the units. The produce sales promotion system 100 which is communicatively connected with the seller terminal 10 and the purchaser terminal 20 to receive relevant information from the seller terminal and/or the purchaser terminal 20.

A seller may be connected to the product sales promotion system 100 by using a seller terminal 10 through wired and wireless network. A purchaser may be connected to the product sales promotion system 100 by using a purchaser terminal 20 through the wired and wireless network. The seller terminal 10 and the purchaser terminal 20 may be or include devices for transmitting and receiving data to and from the product sales promotion system 100 connected thereto, and for example, desktop computers, laptops, smart phones, tablet computers, and so on may be used as the seller terminal 10 and the purchaser terminal 20. However, the seller terminal 10 and the purchaser terminal 20 are not limited to those mentioned above.

The seller and the purchaser may be members who join in the product sales promotion system 100, and the members of the product sales promotion system 100 may have a member account unit 140 connected to their own accounts. The member account unit 140 may include a cyber money account and a cash account. The cyber money deposited in the cyber money accounts may be used to decide distribution amounts for the respective purchasers. Thus, the cyber money deposited into the cyber money accounts may provide a distribution standard for distributing a dividend of a priority member, which will be discussed later, and the dividend of the purchaser and the dividend of the priority member are put into the cyber money accounts in the form of cyber money. The cash in the cash accounts may be transferred to the cyber money accounts, exchanged with the cyber money in the rate of 1:1 or in a predetermined ratio, and deposited into the cyber money accounts. Contrarily, the cyber money in the cyber money accounts may be transferred to the cash accounts, but in this case, desirably, a withdrawal fee at a given percentage for the transferring money has to be paid. The withdrawal fee may be transferred to the system account unit 170 of the product sales promotion system 100, and the cash may be transferred to the cash accounts of the members. The cyber money may be referred to as different names, for example, reward points, mileages, coupons, credits, gifts, incentives, energy currency, etc.

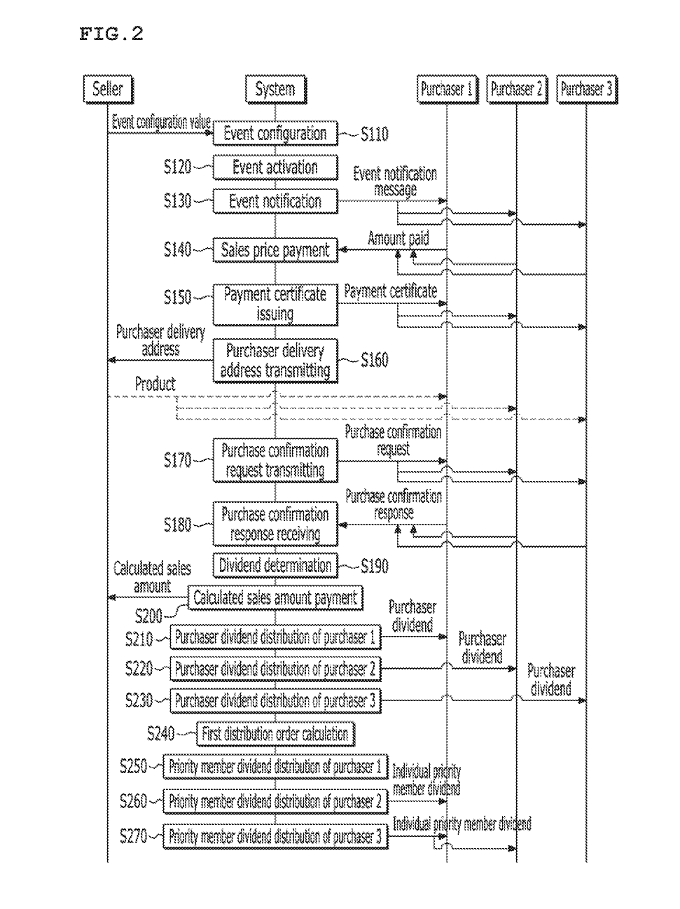

FIG. 2 is an exemplary flowchart showing processes of selling products and distributing a dividend in the product sales promotion system according to an implementation of the disclosed technology.

The seller is connected to the product sales promotion system 100 by using the seller terminal 10, and he or she selects an event configuration menu so as to set an event through which the dividend corresponding to a portion of the paid sales price is distributed to the purchaser and other members. The event configuration unit 110 displays, on the seller terminal 10, an input screen where, as event configuration values, a product category, a product name, the number of products to be sold, a period of time for product sales, a usage period of a product, a sales price of a product, a dividend distribution rate, a purchaser distribution rate, a priority member distribution rate, an period of time of order calculation, a priority member distribution range and so on are inputted, and the seller inputs, on the seller terminal 10, the event configuration values as required through the seller terminal 10. The values inputted to the event configuration unit 110 through the seller terminal 10 are stored in the event configuration unit 110, thereby completing setting the event (at step S110).

The event configuration values may be arbitrarily determined by the seller, and some of them may be suggested with appropriate values by means of the product sales promotion system 100. Further, some of them are, in advance, calculated as optimized values by means of the product sales promotion system 100 and provided as fixed values.

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, the order calculation period and the priority member distribution range will be explained later.

The event management unit 120 activates the event set on the event configuration unit 110 by the seller through the seller terminal 10 (at step S120).

If the event is activated, the event management unit 120 transmits an event notification message to the terminals of the members joined in the product sales promotion system 100 (at step S130). The members may register the products in which they are interested on member information, and the event management unit 120 may transmit the event notification message only to the members who have registered the products under the event as their interested products.

For the conveniences of the description, only purchasers 1, 2 and 3 are illustrated in FIG. 2, and the exemplary case wherein their first distribution order is determined in the order of the purchasers 1, 2 and 3 will be explained below.

So as to purchase the product, the purchaser makes a payment for the sales price of the product on the payment screen provided on the purchaser terminal 20 by the product payment unit 130 (at step S140), and the paid amount for the sales price is deposited into the system account unit 170. The payment may be made by the cyber money and/or the cash withdrawn from the cyber money account and/or cash account of the purchaser, the card sales amount received from a credit card company of the purchaser, and the payment amount received from a smart phone communication company of the purchaser. The payment may be made in various ways including online/offline payment method, and a detailed explanation on the payment method will be omitted.

If the payment for the product is made, the event management unit 120 issues a payment certificate and transfers the payment certificate to the purchaser terminal 20 (at step S150). The payment certificate may have a form of an electronic image.

The delivery management unit 180 may transmit a delivery address and a payment certificate of the purchaser who makes a payment for the sales price of the product to the seller terminal 10 to allow the seller to deliver the product to the purchaser (at step S170). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 190 may transmit a purchase confirmation request to the purchaser who receives the product through the delivery service or directly receives the product from the seller (at step S170).

The purchase confirmation management unit 190 may receive the response to the purchase confirmation request from the purchaser (at step S180). The response to the purchase confirmation request is either a purchase confirmation response or a purchase cancel response. The purchase cancel response is the purchaser's expression to get a refund in case where the product purchased is unsatisfied. In this case, the event management unit 120 pays the paid amount as a refund to the purchaser who transmits the purchase cancel response. The refund is withdrawn from the amount kept in the system account unit 170 and is thus transferred to the cash account of the purchaser who transmits the purchase cancel response. Hereinafter, an explanation on the case where the response to the purchase confirmation request is the purchase confirmation response will be given.

If a first period of time of order calculation ends after the event is activated, the dividend distribution unit 160 multiplies the sum of the paid amounts of the purchaser who performs the purchase confirmation response within the first period of time of order calculation by the dividend distribution rate to determine the dividend generated by the purchaser (at step S190)

The period of time of order calculation may be set with a given period of time or in real time, and the given period of time may be set with a period of 12 hours, one day, or one week. If the period of time of order calculation ends, the distribution order is updated. If the period of time of order calculation is set in real time, the distribution order is updated right after the payments and purchase confirmations of the purchasers are finished.

The event management unit 120 may pay the amount of product sales calculated by subtracting the dividends from the total amount of product sales (which is calculated by multiplying the sales price by the number of purchase confirmed products) to the cash account of the seller (at step S200).

A portion of the dividend determined at the step S190 is first distributed to the purchaser himself or herself. Hereinafter, the dividend distributed to the purchaser is called “purchaser dividend”.

The dividend distribution unit 160 may multiply the dividend calculated by multiplying the sum of amounts paid by the purchaser 1 within the first period of time of order calculation by the dividend distribution rate by the purchaser distribution rate to calculate the purchaser dividend, and transfer the purchaser dividend to the cyber money account of the purchaser 1 (at step S210).

The dividend distribution unit 160 may multiply the dividend calculated by multiplying the sum of amounts paid by the purchaser 2 within the first period of time of order calculation by the dividend distribution rate by the purchaser distribution rate to calculate the purchaser dividend, and transfer the purchaser dividend to the cyber money account of the purchaser 2 (at step S220).

The dividend distribution unit 160 multiplies the dividend calculated by multiplying the sum of amounts paid by the purchaser 3 for the first period of time of order calculation by the dividend distribution rate, by the purchaser distribution rate to calculate the purchaser dividend, and transfers the purchaser dividend to the cyber money account of the purchaser 3 (at step S230).

In this case, an explanation on the steps S210 to S230 which are sequentially performed is given, but the steps may be performed concurrently or in a reverse order to each other.

The order calculation unit 150 calculates a first distribution order on the basis of the purchaser dividends distributed to the purchasers (at step S240). The distribution order is the order of the members that is determined according to the amounts of cyber money deposited into the cyber money accounts of the members joined in the product sales promotion system 100. The first distribution order is the order determined after adding the purchaser dividend distributed to the member as the purchaser for the first period of time of order calculation to the amount of cyber money deposited into the cyber money account of the member before the activation of the event. In this case, the member may exchange cash into the cyber money and transfer the cyber money to the cyber money account, thereby increasing the amount of cyber money in the cyber money account.

The rest of dividend calculated by subtracting the purchaser dividend from the dividend determined at the step S190 is distributed to all or some of the members who rank ahead the purchaser in the first distribution order (hereinafter, referred to as “priority members”) according to a predetermined priority member distribution way. The dividend distributed to all or some of the priority members according to the priority member distribution way, which is the amount calculated by subtracting the purchaser dividend from the dividend, is called “priority member dividend”, and a priority member dividend distributed by individual is called “individual priority member dividend”. The individual priority member dividends are transferred to the cyber money accounts of all or some of the priority members in the form of cyber money.

The recipients of the priority member dividends may be selected among the all members joined in the product sales promotion system 100 or only among the purchasers who purchase the products sold through the event. That is, the distribution order may be calculated with respect to the all members or only the purchasers who purchase the products sold through the event.

The priority member distribution range means the range of the priority members who receive the distribution among the priority members, and “distribution to all of the priority members” and “distribution to some of the priority members” may be selected by the seller or the system. Hereinafter, an explanation on the case where the dividend distribution unit 160 distributes the priority member dividend to all of the priority members will be given.

If the first distribution order is determined, the dividend distribution unit 160 has to distribute the priority member dividend which is the remaining amount calculated by subtracting the purchaser dividend from the dividend generated by the purchaser 1 to the priority members to the purchaser 1 according to the priority member distribution way. Since the priority members to the purchaser 1 do not exist, however, the priority member dividend is transferred to the system account unit 170 (at step S250).

The dividend distribution unit 160 may distribute the priority member dividend which is the remaining amount after subtracting the purchaser dividend from the dividend generated by the purchaser 2 to the priority member (that is, the purchaser 1) who ranks ahead the purchaser 2 according to the priority member distribution method (at step S260).

The dividend distribution unit 160 may distribute the priority member dividend which is the remaining amount after subtracting the purchaser dividend from the dividend generated by the purchaser 3 to the priority members (that is, the purchaser 1 and the purchaser 2) who rank ahead the purchaser 3 according to the priority member distribution method (at step S270).

The purchaser dividends and the priority member dividends are withdrawn from the amount kept in the system account unit 170 and are transferred to the cyber money accounts of the purchasers and the priority members. The purchaser dividends and the priority member dividends are paid in cyber money, but it is possible that those are transferred in cash to the cash accounts of the purchasers and the priority members.

Next, a second period of time of order calculation starts, and the steps S140 to S230 are repeatedly carried out. Second distribution order, which is used for the distribution of the priority member dividends for the second period of time of order calculation, is determined on the basis of the individual priority member dividends transferred to the cyber money accounts of the priority members for the first period of time of order calculation and the purchaser dividends transferred to the cyber money accounts of the purchasers for the second period of time of order calculation. Updating the distribution order is performed in a such way whenever the order calculation periods of time pass.

The dividend distribution unit 160 may distribute the priority member dividend only to some of the priority members. In this case, the some of the priority members are selected according to the distribution order in order from the top priority member or are randomly selected.

An exemplary case where some of the priority members are selected as the priority member distribution range according to the distribution order from the top priority member will be explained. For example, the priority member dividend generated by the purchase who is the 100th in the distribution order is not distributed to all of the 99 priority members, but to some of the priority members such as the priority members who are first to 70th, first to 50th, or first to 30th are firstly selected, the priority member dividends may be distributed only to the selected priority members according to the priority member distribution method on the basis of the distribution order.

An exemplary case where some of the priority members are randomly selected as the priority member distribution range will be explained. For example, the priority member dividend generated by the purchase of the purchaser who is the 100th in the distribution order is not distributed to all of the 99 priority members, but to 70, 50, or 30 priority members who are randomly selected from the 99 priority members, the priority member dividends are distributed only to the selected priority members according to the priority member distribution method on the basis of the distribution order.

In the product sales promotion system and method according to an implementation of the disclosed technology, the priority member distribution method is freely determined by the seller or the system. A desirable example of the priority member distribution method may be as follows.

The dividend distribution unit 160 may arrange the priority members in the order of the distribution. Next, a first individual priority member dividend calculated by multiplying the priority member dividend by the priority member distribution rate is paid to a first member who is the first in distribution order, and a second individual priority member dividend calculated by multiplying the amount remaining after subtracting the first individual priority member dividend from the priority member dividend by the priority member distribution rate is paid to a second member who is the second in the distribution order.

In this example, only the first and second priority members are exemplified, but in the same manner as above, the individual priority member dividends may be paid to the priority members who are next to the first and second priority members. For example, a third individual priority member dividend calculated by multiplying the amount remaining after subtracting the first individual priority member dividend and the second individual priority member dividend from the priority member dividend by the priority member distribution rate is paid to a third member who is the third in the distribution order.

If the priority member dividend remains even after the individual priority member dividends are paid to all of the priority members, the priority member dividend calculated by multiplying the remaining priority member dividend by the priority member distribution rate may be paid in the order of the priority members from the first members in the same manner as above. However, if the remaining priority member dividend is less than a predetermined amount, the dividend distribution unit 160 may transfer the remaining priority member dividend to the system account unit 170 and finish the priority member dividend distribution.

According to another desirable example of the priority member distribution method, the priority member dividend may be divided into N (wherein N=the number of priority members+1), and the divided priority member dividends may be paid equally to the priority members.

If the purchasers purchase the products during the event through the product sales promotion system and method according to an implementation of the disclosed technology, the purchaser dividends and the priority member dividends are continuously distributed, so that the assets of the purchasers are increased through their purchase and the purchase of other members. Now, the effects obtained by the system and method according to the disclosed technology will be explained with an exemplary case.

A seller A who sells clothing in America determines to sell 7 kinds of clothes at the lowest price on online through the product sales promotion system 100 according to an implementation of the disclosed technology, and the sales prices of the 7 kinds of clothes to be sold by the seller A are 5, 8, 10, 20, 50, 100 and 200 dollars respectively. The following event configuration values are inputted by the seller A.

Target period of product sales: three days

Period of time of order calculation: one day

Dividend distribution rate: 10%

Purchaser distribution rate: 40%

Priority member distribution method: Even distribution to N including purchasers

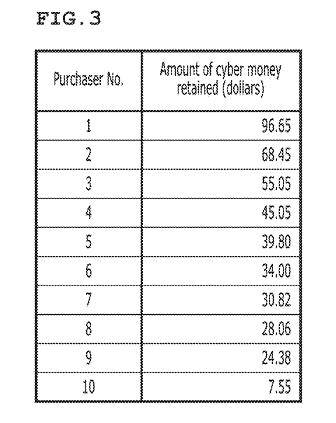

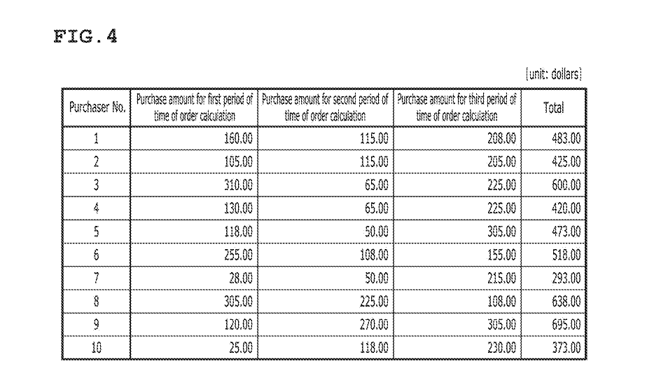

The first distribution order is determined according to the amounts of cyber money deposited into the cyber money accounts of 10 purchasers, and the amounts of cyber money of the 10 purchasers and the initial distribution order determined according to the amounts of cyber money of the 10 purchasers are listed in FIG. 3. The 10 purchasers randomly purchase three pieces of clothing every day for three days, and the purchase amounts of the 10 purchasers by one day are listed in FIG. 4.

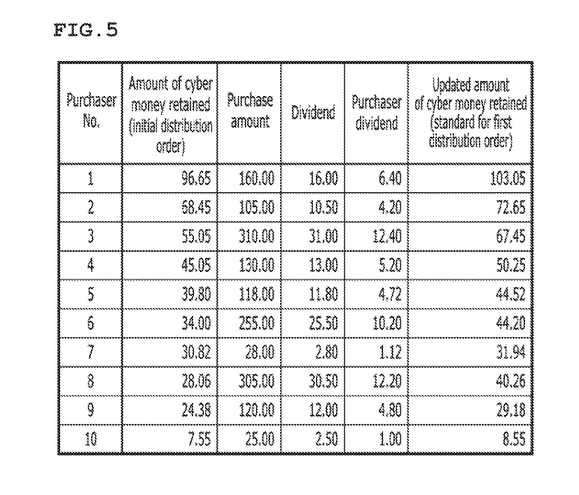

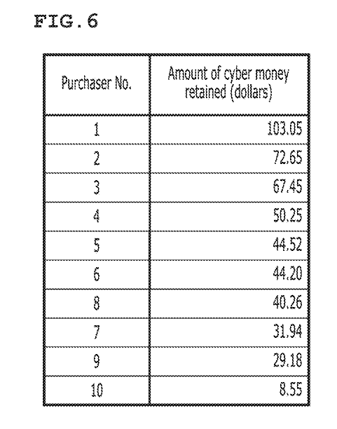

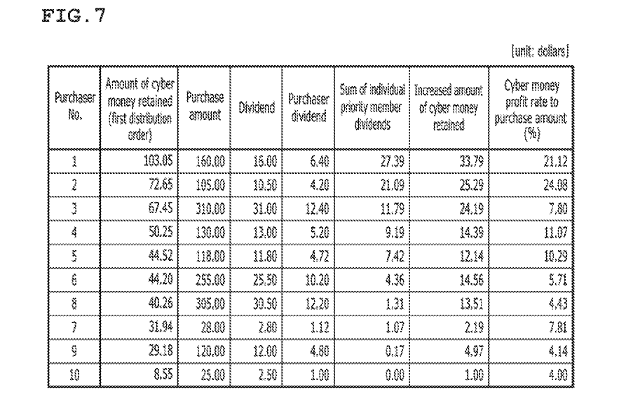

FIG. 5 is an exemplary table showing the purchaser dividends transferred to the purchasers for a first period of time of order calculation and the amounts of cyber money retained updated on the basis of the purchaser dividends, which will be a standard for the first distribution order. FIG. 6 is an exemplary table showing the first distribution order. FIG. 7 is an exemplary table showing amounts transferred to the purchasers and profit rates of the purchasers for the first period of time of order calculation.

The purchaser 1 is the first purchaser in the initial distribution order and buys 160 dollars clothing for the first period of time of order calculation. As soon as the first period of time of order calculation passes, 16.00 dollars corresponding to 10% (dividend distribution rate) of 160 dollars paid by the purchaser 1 are determined as the dividend generated by the purchaser 1. Next, 6.40 dollars, as a purchaser dividend, corresponding to 40% (purchaser distribution rate) of the dividend are transferred to the cyber money account of the purchaser 1. Through the increment of the purchaser dividend, the amount of cyber money of 96.65 dollars of the purchaser 1 is increased to 103.05 dollars. The purchaser 8 pays 305.00 dollars, and 12.20 dollars as the purchaser dividend are transferred to the cyber money account of the purchaser 8. As a result, the amount of cyber money of 28.06 dollars of the purchaser 8 is increased to 40.26 dollars, which is greater than the amount of cyber money of 31.94 dollars of the purchaser 7 who pays 28.00 dollars, so that the first distribution order of the purchaser 8 is upgraded one step. Accordingly, the purchaser increases his or her purchase amount to upgrade his or her distribution order, thereby obtaining a substantially large amount of individual priority member dividend.

The first distribution order is determined on the basis of the updated amounts of cyber money, and the individual priority member dividend is distributed on the basis of the first distribution order. In detail, 9.60 dollars corresponding to the amount calculated after subtracting the purchaser dividend from the dividend are transferred to the system account unit because the priority members to the purchaser 1 do not exist. Also, the priority member dividend is calculated after subtracting the purchaser dividend from the dividend corresponding to 10% (dividend distribution rate) of the amount paid by each of the purchasers 2 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 1. That is, the purchaser 1 has 27.39 dollars as the sum of the individual priority member dividends (the individual priority member dividend of 6.30 dollars transferred from the purchaser 2, the individual priority member dividend of 9.30 dollars transferred from the purchaser 3, the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 1 has purchased clothing of 160 dollars at the lowest price on online for the first period of time of order calculation, so that his or her assets of 33.79 dollars (the sum of the purchaser dividend of 6.40 dollars and the sum of the individual priority member dividends of 27.39 dollars) are increased. Also, a cyber money profit rate to the purchase amount of the purchaser 1 for the first period of time of order calculation is 21.12%.

The purchaser 2 is the second purchaser in the initial distribution order and spends 105 dollars on clothing for the first period of time of order calculation. As soon as the first period of time of order calculation passes, 10.50 dollars corresponding to 10% (dividend distribution rate) of 105 dollars paid by the purchaser 2 is determined as the dividend generated by the purchaser 2. Next, 4.20 dollars, as a purchaser dividend, corresponding to 40% (purchaser distribution rate) of the dividend are transferred to the cyber money account of the purchaser 2. Through the increment of the purchaser dividend, the amount of cyber money of 68.45 dollars of the purchaser 2 is increased to 72.65 dollars.

That is, 6.30 dollars corresponding to the amount calculated after subtracting the purchaser dividend from the dividend of the purchaser 2 are transferred to the cyber money account of the purchaser 1 as the priority member to the purchaser 2. Also, the priority member dividend is calculated after subtracting the purchaser dividend from the dividend corresponding to 10% (dividend distribution rate) of the amount paid by each of the purchasers 3 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 2. That is, the purchaser 2 has 21.09 dollars as the sum of the individual priority member dividends (the individual priority member dividend of 9.30 dollars transferred from the purchaser 3, the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 3 is the third purchaser in the initial distribution order and spends 310 dollars on clothing for the first period of time of order calculation. As soon as the first period of time of order calculation passes, 31.00 dollars corresponding to 10% (dividend distribution rate) of 310 dollars paid by the purchaser 3 are determined as the dividend generated by the purchaser 3. Next, 12.40 dollars, as a purchaser dividend, corresponding to 40% (purchaser distribution rate) of the dividend are transferred to the cyber money account of the purchaser 3. The purchaser dividend of the purchaser 3 is increased so that the amount of cyber money of 55.05 dollars is increased to 67.45 dollars.

Next, 18.60 dollars corresponding to the amount calculated after subtracting the purchaser dividend from the dividend of the purchaser 3 are transferred to the cyber money accounts of the purchaser 1 and the purchaser 2 as the priority members, so that 9.30 dollars are transferred to the cyber money accounts of the purchaser 1 and the purchaser 2, respectively. Also, the priority member dividend is calculated after subtracting the purchaser dividend from the dividend corresponding to 10% (dividend distribution rate) of the amount paid by each of the purchasers 4 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 3. That is, the purchaser 3 has 11.79 dollars as the sum of the individual priority member dividends (the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 4 is the fourth purchaser in the initial distribution order and spends 130 dollars on clothing for the first period of time of order calculation. As soon as the first period of time of order calculation passes, 13.00 dollars corresponding to 10% (dividend distribution rate) of 130 dollars paid by the purchaser 4 are determined as the dividend generated by the purchaser 4. Next, 5.20 dollars, as a purchaser dividend, corresponding to 40% (purchaser distribution rate) of the dividend are transferred to the cyber money account of the purchaser 4. The purchaser dividend of the purchaser 4 is increased so that the amount of cyber money of 45.05 dollars is increased to 50.25 dollars.

Next, 7.80 dollars corresponding to the amount calculated after subtracting the purchaser dividend from the dividend of the purchaser 4 are transferred to the cyber money accounts of the purchaser 1, the purchaser 2 and the purchaser 3 as the priority members, so that 2.60 dollars are transferred into the cyber money accounts of the purchaser 1, the purchaser 2, and the purchaser 3, respectively. Also, the priority member dividend is calculated after subtracting the purchaser dividend from the dividend corresponding to 10% (dividend distribution rate) of the amount paid by each of the purchasers 5 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 4. That is, the purchaser 4 has 9.19 dollars as the sum of the individual priority member dividends (the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 4 has purchased clothing of 130 dollars for the first period of time of order calculation, and that is, the 130 dollars are just the amount corresponding to 41.9% of the purchase amount (310 dollars) of the purchaser 3. In this case, however, a cyber money profit rate to the purchase amount of the purchaser 4 is 11.07%, which is higher than the cyber money profit rate to the purchase amount of the purchaser 3 of 7.80%. The purchaser 7 has purchased clothing of 28 dollars for the first period of time of order calculation, and that is, the 28 dollars are just the amount corresponding to 9.2% of the purchase amount (305.00 dollars) of the purchaser 8. In this case, however, a cyber money profit rate to the purchase amount of the purchaser 7 is 7.81%, which is higher than the cyber money profit rate to the purchase amount of the purchaser 8 of 4.43%. Therefore, the product sales promotion system according to an implementation of the disclosed technology has different structures and effects from the conventional point saving system in which points proportional to purchase amounts are simply saved. Under the product sales promotion system according to an implementation of the disclosed technology, even if the purchaser purchases the products with a relatively low purchase amount, his or her cyber money profit rate to the purchase amount can be higher than other purchasers.

Through such exceptionality of the cyber money profit rate to the purchase amount, even the low-order purchasers in the distribution order hope that they will have the cyber money profit rate to the purchase amount higher than the priority members and also their distribution order will be raised, so that the purchase of all of the purchasers who are in the distribution order can be promoted.

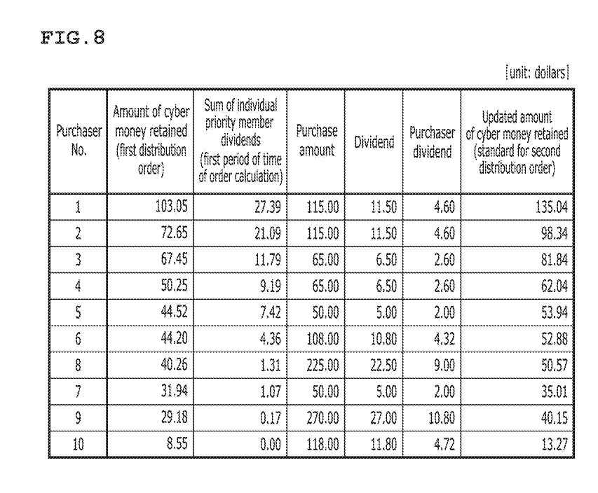

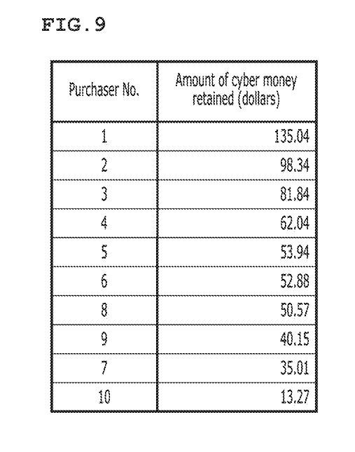

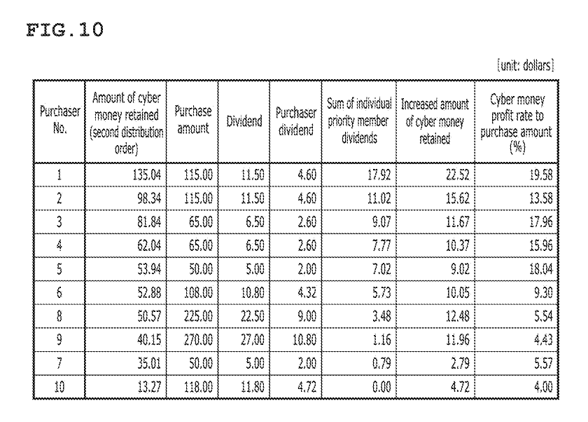

FIG. 8 is an exemplary table showing the purchaser dividends transferred to the purchasers for a second period of time of order calculation and the amounts of cyber money retained updated on the basis of the sum of individual priority member dividends for the first period of time of order calculation and the purchaser dividends for the second period of time of order calculation, which will be a standard for the second distribution order. FIG. 9 is an exemplary table showing the second distribution order. FIG. 10 is an exemplary table showing amounts transferred to the purchasers and profit rates of the purchasers for the second period of time of order calculation.

In the first distribution order, the amount of cyber money of the purchaser 7 is 31.94 dollars and that of the purchaser 9 is 29.18 dollars, and accordingly, the first distribution order of the purchaser 7 is higher than that of the purchaser 9. Through the sum of individual priority member dividends for the first period of time of order calculation and the purchaser dividends for the second period of time of order calculation, the amount of cyber money of the purchaser 7 is 35.01 dollars and that of the purchaser 9 is 40.15 dollars, so that the purchaser 9 is higher than the purchaser 7 in the second distribution order as a dividend distribution standard for the second period of time of order calculation.

The purchaser 5 has purchased clothing of 50.00 dollars for the second period of time of order calculation, and that is, the 50.00 dollars are just the amount corresponding to 43.5% of the purchase amount of 115.00 dollars of the purchaser 2. In this case, however, a cyber money profit rate to the purchase amount of the purchaser 5 is 18.04%, which is higher than the cyber money profit rate to the purchase amount of the purchaser 2 of 13.58%. Also, the purchaser 3 has purchased clothing of 65.00 dollars for the second period of time of order calculation, and that is, the 65.00 dollars are just the amount corresponding to 56.5% of the purchase amount of 115.00 dollars of the purchaser 2. In this case, however, a cyber money profit rate to the purchase amount of the purchaser 3 is 17.96%, which is higher than the cyber money profit rate to the purchase amount of the purchaser 2 of 13.58%. It can be appreciated again that under the product sales promotion system according to an implementation of the disclosed technology, therefore, even if the purchaser purchases the products with a relatively low purchase amount, his or her cyber money profit rate to the purchase amount can be higher than other purchasers.

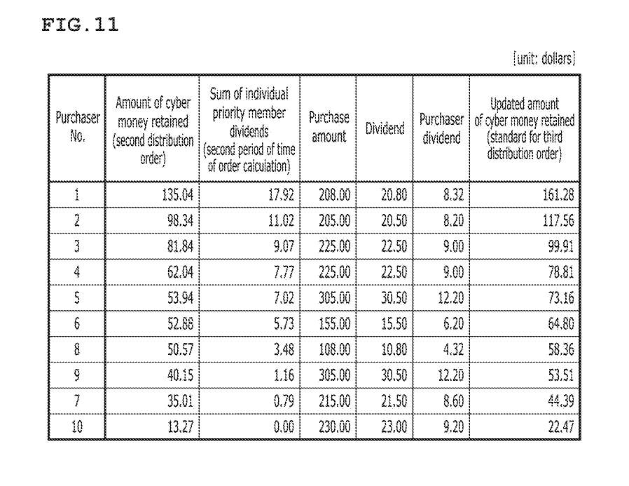

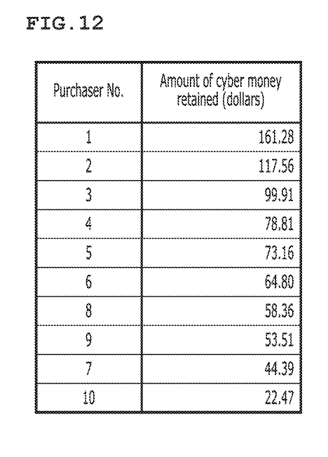

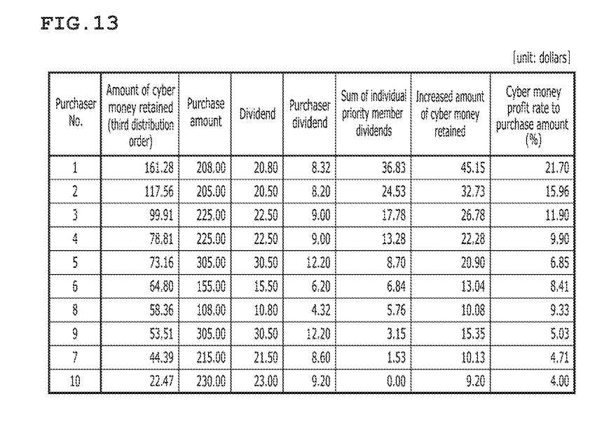

FIG. 11 is an exemplary table showing the purchaser dividends transferred to the purchasers for a third period of time of order calculation and the amounts of cyber money retained updated on the basis of the sum of individual priority member dividends for the second period of time of order calculation and the purchaser dividends for the third period of time of order calculation, which will be a standard for the third distribution order. FIG. 12 is an exemplary table showing the third distribution order. FIG. 13 is an exemplary table showing amounts transferred to the purchasers and profit rates of the purchasers for the third period of time of order calculation.

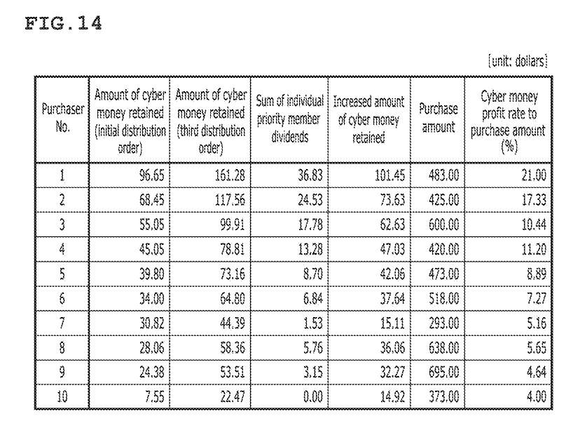

FIG. 14 is an exemplary table showing cyber money profit rates to the purchase amounts of the purchasers during an event.

While the purchaser 1 is retaining the cyber money of 96.65 dollars before the event, he or she purchases 9 pieces of clothing at the lowest online price of 483.00 dollars during the event for three days, so that additionally, the cyber money of the purchaser 1 is increased to 101.45 dollars. The cyber money profit rate to the purchase amount of the purchaser 1 is 21.00%. It can be also checked that the amounts of cyber money of other purchasers are increased. With a payment of the withdrawal fee, the cyber money may be transferred to the cash account from the cyber money account in the form of cash or may be withdrawn directly from the cyber money account in the form of cash, so that the cash assets of the purchaser can be increased. Further, the distribution order of the purchaser can be upgraded by means of the amount of cyber money distributed to him or her, thereby providing a big possibility that a larger amount of dividend on another event is distributed to him or her.

If the payment of the purchaser is made through the use of an interest-free installment program provided by a credit card company, the profit of the purchaser will be maximized. If the purchaser buys 483.00 dollar clothing in the conventional purchase system, he or she must prepare 483.00 dollars, which makes him or her feel burdened so that he or she is refrained from purchasing the clothing. Through the product sales promotion system 100 of the disclosed technology, the sales price is paid in interest-free installments, and next, the installment amount may be paid with the dividend distributed to the purchaser, thereby lessening the burden of the purchaser. Such an advantage is obtained because the value of time is turned into the cyber money. Particularly, if the dividend distribution rate is raised by the seller, the amounts to be distributed to the purchasers are increased, so that the consumption will and event join will of the members become high.

The seller accomplishes a substantially larger amount of sales than an amount of sales in the past, for a short period of time, thereby obtaining a great sales profit, and even if the dividend is distributed, an amount of sales over several months to years can be obtained within the short period of time, so that no damage occurs. Also, the dividend, as a sales agency commission, is the amount paid to the system provider of the conventional system, and therefore, the seller does not have any substantial damage even if seller distributes the dividend. So as to increase the amount of sales in a short period of time, the dividend distribution rate may be selectively raised by the seller, which strongly stimulates the event join desires of the members to rapidly and reliably achieve a desired amount of product sales.

The product sales promotion system of an implementation of the disclosed technology may obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment may be conducted by means of the system usage fees, the withdrawal fees, and the cash balance in the system account, thereby creating great profits.

The members may withdraw the cyber money from their cyber money accounts and exchange the cyber money into the cash, or they may get a loan with their cyber money as collateral from the product sales promotion system. The members may exchange their cyber money into the cash with a payment of the withdrawal fees, but in this case, the amount of cyber money retained in the cyber money account is decreased and this may cause a disadvantage in ranking of the dividend distribution order of an event. So as to allow the member to exchange the cyber money into the cash in the state where the amount of cyber money retained is kept, the product sales promotion system may lend the cash of the system account unit to the members with the cyber money of the members as collateral. As a result, the product sales promotion system may provide a financial business.

It may be appreciated that the product sales promotion system according to an implementation of the disclosed technology provides a consuming-tech (consumption+financial technology) system that increases wealth through consumption, and as increased consumption may increase wealth, so that consumption, commercial exchange, and turnover rate are optimized to achieve significant advance in E-commerce unlike the conventional one.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve described results. Moreover, the separation of various system components in the embodiments described in this patent document should not be understood as requiring such separation in all embodiments. Only a few implementations and examples are described. Other implementations, enhancements and variations can be made based on what is described and illustrated in this patent document.

What is claimed is:

1. A product sales promotion method for selling products through a product sales promotion system, the method comprising the steps of:
(a) making the payment for a sales price of the product by a terminal of a purchaser, for a first period of time of order calculation, through a product payment unit;
(b) transferring cyber money corresponding to a portion of a dividend obtained by multiplying a paid amount for the sales price by a dividend distribution rate to a member account unit of the purchaser, through a dividend distribution unit;
(c) determining a first distribution order according to a cyber money amount deposited into the member account unit, through an order calculation unit; and
(d) transferring cyber money corresponding to a remaining dividend to the member account units of at least some of members who rank ahead the purchaser in the first distribution order (hereinafter, referred to as “priority members”), by a dividend distribution unit.

2. The product sales promotion method according to claim 1, wherein the portion of the dividend at the step (b) is a purchaser dividend calculated by multiplying the dividend by a purchaser dividend rate, and the remaining dividend at the step (d) is a priority member dividend calculated by subtracting the purchaser dividend from the dividend, and
wherein the priority member dividend is divided into individual priority member dividends according to a priority member distribution way, and the individual priority member dividends are transferred to the member account units of the at least some of priority members.

3. The product sales promotion method according to claim 2, wherein the order calculation unit determines a second distribution order, for a second period of time of order calculation, on the basis of the purchaser dividends transferred for the second period of time of order calculation and the individual priority member dividends transferred for the first period of time of order calculation.

4. The product sales promotion method according to claim 2, wherein the priority member distribution way comprises the steps of:
arranging the priority members according to the first distribution order;
distributing a first individual priority member dividend obtained by multiplying the priority member dividend by a priority member distribution rate to a first member who is a first in the first distribution order; and
distributing a second individual priority member dividend obtained by multiplying an amount remained after subtracting the first individual priority member dividend from the priority member dividend by the priority member distribution rate to a second member who is a second in the first distribution order.

5. The product sales promotion method according to claim 2, wherein the priority member distribution way distributes the priority member dividend to the at least of priority members equally.

6. The product sales promotion method according to claim 3, wherein the step of determining the second distribution order is carried out in real time.

7. The product sales promotion method according to claim 3, wherein the first distribution order and the second distribution order are determined with respect to all of the members joined in the product sales promotion system.

8. The product sales promotion method according to claim 3, wherein the first distribution order and the second distribution order are determined with respect to only the purchasers who purchase the products.

9. The product sales promotion method according to claim 1, wherein the at least some of priority members are all of the priority members.

10. The product sales promotion method according to claim 1, wherein the at least some of priority members are selected according to the distribution order in the order from a top priority member.

11. The product sales promotion method according to claim 1, wherein the at least some of priority members are selected randomly selected among the priority members.

12. The product sales promotion method according to claim 1, wherein the cyber money transferred directly from the member is deposited into the member account unit.
